(19) United States
(12) Patent Application Publication
(10) Pub. No.: US 2013/0222284 A1
(43) Pub. Date: Aug. 29, 2013

(54) TERMINAL HAVING TOUCH-INPUT DISPLAY AND MANUFACTURING METHOD THEREFOR

(71) Applicant: Pantech Co., Ltd., (US)

(72) Inventor: Ki Ung KIM, Seoul (KR)

(73) Assignee: Pantech Co., Ltd., Seoul (KR)

(21) Appl. No.: 13/669,973

(22) Filed: Nov. 6, 2012

(30) Foreign Application Priority Data
Feb. 24, 2012 (KR) 10-2012-0019236

(51) Int. Cl. G06F 3/041

(52) U.S. Cl. 345/173

(57) ABSTRACT

A terminal includes a touch panel having a first surface, a display panel having a second surface configured to face the first surface, and an attraction reduction layer disposed on at least one of the first surface and the second surface to reduce attraction between the first surface and the second surface. A method for manufacturing a touch-input display includes disposing a first pattern on at least one of a first surface of a touch panel and a second surface of a display panel, the first pattern facing the other of the first surface and the second surface to reduce attraction between the first surface and the second surface, and arranging the touch panel and the display panel to have a gap layer between the touch panel and the display panel.

### CROSS-REFERENCE TO RELATED APPLICATION

This application claims priority from and the benefit under 35 U.S.C. §119(a) of Korean Patent Application No. 10-2012-0019236, filed on Feb. 24, 2012, which is hereby incorporated by reference as if fully set forth herein.

### BACKGROUND

1. Field

The present disclosure relates to a mobile device and a manufacturing method therefor, and more specifically, to a mobile device capable of reducing an optical interference phenomenon between a touch panel and a display panel by forming an attraction reduction unit to reduce the optical interference phenomenon and a manufacturing method therefor.

2. Discussion of the Background

There is a trend that the sizes and thicknesses of mobile devices and home appliances are decreasing. Small and thin mobile devices enable users to carry the mobile device more conveniently; however, the decreasing size of the mobile device is one of the important constraints when designing a mobile device. On the other hand, the relative size of a display screen in comparison with the exterior housing has been increased due to the wide adoption of a touch screen embedded mobile device having an input type (an electrostatic type, a constant pressure type, an infrared type, or the like) using a touch sensor on a display screen.

FIG. 1 is a diagram illustrating a display unit 1 of a mobile device according to the related art. Referring to FIG. 1, the display unit 1 providing a touch sensor includes a touch panel 10, a display panel 20, and a side surface support portion 31 disposed between the touch panel 10 and the display panel 20 so as to arrange the touch panel 10 and the display panel 20 to be parallel to each other with a predetermined gap therebetween. In the gap S, a layer filled with air is formed between the touch panel 10 and the display panel 20.

Referring to FIG. 1, an oil slick (i.e., Newton's rings or optical interference) phenomenon may occur when the touch panel 10 is curved due to an external force applied thereto while operating the touch panel 10 having the touch sensor or a pressure applied thereto from a peripheral object when a user puts the mobile device in a pocket or a bag for a long period of time without using the mobile device.

The optical interference phenomenon may occur due to a vacuum state caused by a physical attraction generated by the van der Waals force exerted between two objects having smooth surfaces when the two objects are coming into contact with each other.

Conventional mobile devices were relatively thick and the display screen surface areas were relatively small. Since the mobile devices were thick (the gap S between the touch panel 10 and the display panel 20 is generally 0.5 mm or more) and the display panel 20 was small, the optical interference phenomenon did not occur. When the thickness of a mobile device is relatively big, there is a low possibility that the touch panel 10 and the display panel 20 are in contact with each other due to the sufficient gap therebetween. Even when the size is small, the degree in which the touch panel is curved is small due to the support force which is exerted by the side surface support portion 31, and hence there is a low possibility that two panels may be absorbed to each other.

However, the deformation degree of the touch panel or the display panel caused by the external force F gradually increases due to the decreasing tendency in the thickness of the mobile devices and the increasing tendency in size of the display screen. In particular, the deformation degree L becomes more severe in the case of the tablet product having a wider display screen than smartphones.

Thus, there are various attempts to resolve the optical interference problem through adjustments of such factors for preventing deformations and optical interference problems.

FIG. 2 is a cross-sectional view illustrating a display unit 3 of a mobile device having a laminated structure according to the related art.

As shown in FIG. 1, the gap S of approximately 0.3 to 0.5 mm having air disposed therein is formed between the touch panel 10 and the display panel 20. As the gap becomes narrower, the touch panel 10 and the display panel 20 more easily contact each other, and the optical interference phenomenon more easily occurs.

As shown in FIG. 2, an intermediate layer 50 may be formed between the touch panel 10 and the display panel 20 so that the gap having air is not formed so as to prevent the optical interference phenomenon. The intermediate layer 50 is formed by charging and curing a UV resin between the touch panel 10 and the display panel 20 or attaching the touch panel 10 and the display panel 20 to each other by using an optical clear adhesive (OCA).

In this case, since the touch panel 10 and the display panel 20 do not physically contact each other due to the intermediate layer 50, the optical interference phenomenon does not occur.

However, in the case of the laminated structure, the touch panel 10 and the display panel 20 are integrated with each other so as not to be separated from each other. Accordingly, when any one of the panels is defective, the laminated structure needs to be replaced, which noticeably degrades the yield rate of the product. Furthermore, in the case of the laminated structure, the laminated structure may be defective due to a foreign substance, and this defect may be checked only after the termination of the process, which increases the manufacturing cost of the product. Since the proportion of the touch panel and the display panel is large in the manufacturing cost of the mobile device, these factors drastically affects the price of the product.

Specifically, the touch panel and the display panel need to be separated from each other during the repair of the product, but at this time, the panel may be damaged if separated. Furthermore, there is a problem in which the basic cost increases due to the addition of the adhesive layer for the laminated structure.

### SUMMARY

Exemplary embodiments of the present invention provide a mobile device capable of reducing an optical interference phenomenon between a touch panel and a display panel.

Additional features of the invention will be set forth in the description which follows, and in part will be apparent from the description, or may be learned by practice of the invention.

An exemplary embodiment of the present invention provides a terminal, including: a touch panel having a first surface; a display panel having a second surface configured to face the first surface; and an attraction reduction layer disposed on at least one of the first surface and the second surface to reduce attraction between the first surface and the second surface.

An exemplary embodiment of the present invention provides a method for manufacturing a touch-input display, including: disposing a first pattern on at least one of a first surface of a touch panel and a second surface of a display panel, the first pattern facing the other of the first surface and the second surface to reduce attraction between the first surface and the second surface; and arranging the touch panel and the display panel to have a gap layer between the touch panel and the display panel.

An exemplary embodiment of the present invention provides a mobile device, including: a touch panel including a first electrode having a first electrode pattern; a display panel including a second electrode pattern; a repulsive force generator to generate a repulsive force between the second electrode pattern and the touch panel; and a gap layer between the touch panel and the display panel.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view illustrating a display unit in a mobile device according to the related art.

FIG. 2 is a cross-sectional view illustrating a display unit in the mobile device having a laminated structure according to the related art.

FIG. 3 is a cross-sectional view illustrating a display unit in a mobile device according to an exemplary embodiment of the present invention.

FIG. 4 is a cross-sectional view illustrating a display unit in a mobile device according to an exemplary embodiment of the present invention.

FIG. 5 is a plan view illustrating an optical interference preventing pattern according to exemplary embodiments of the present invention.

FIG. 6 is a cross-sectional view illustrating a display unit in a mobile device according to an exemplary embodiment of the present invention.

FIG. 7 is a cross-sectional view illustrating a display unit in a mobile device according to an exemplary embodiment of the present invention.

FIG. 8 is a cross-sectional view illustrating a display unit in a mobile device according to an exemplary embodiment of the present invention.

FIG. 9 is a cross-sectional view illustrating a display unit in a mobile device according to an exemplary embodiment of the present invention.

FIG. 10 is a flowchart illustrating a method for driving a display unit in a mobile device an exemplary embodiment of the present invention.

FIG. 11 is a process flow diagram illustrating a method for manufacturing a lower electrode of a display unit in a mobile device an exemplary embodiment of the present invention.

FIG. 12 is a process flow diagram illustrating a method for manufacturing an attraction reduction unit of a display unit in a mobile device according to an exemplary embodiment of the present invention.

FIG. 13 is a process flow diagram illustrating a method for manufacturing an attraction reduction unit of a display unit in a mobile device according to an exemplary embodiment of the present invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity, illustration, and convenience.

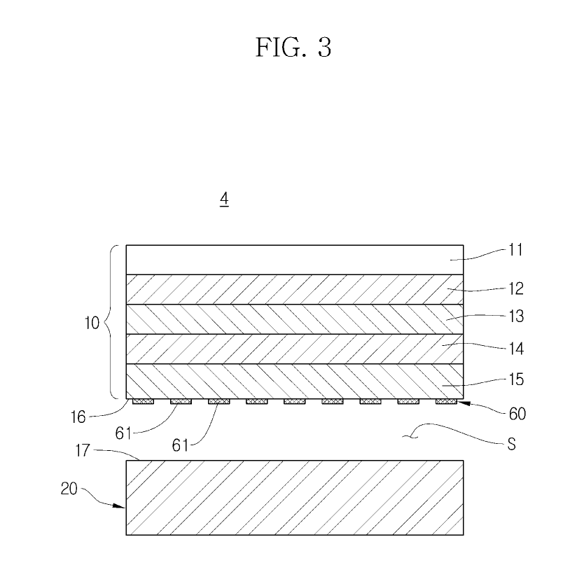

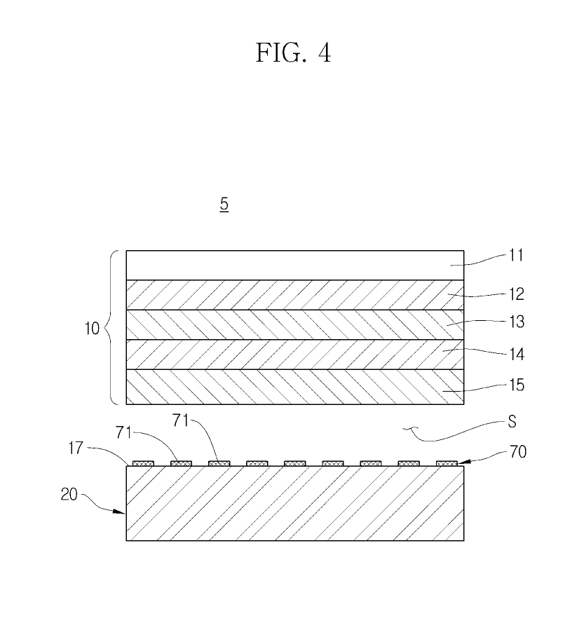

FIG. 3 is a cross-sectional view illustrating a display unit in a mobile device according to an exemplary embodiment of the present invention, and FIG. 4 is a cross-sectional view illustrating display unit in a mobile device according to an exemplary embodiment of the present invention.

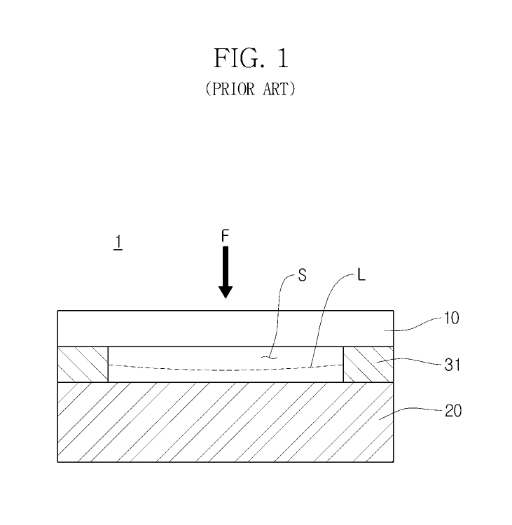

As shown respectively in FIG. 3 and FIG. 4, the display units 4 and 5 in the mobile device include a display panel 20, a touch panel 10, and one or more attraction reduction units 60 and 70, respectively (the attraction reduction unit may be referred to as “attraction reduction layer”). The attraction reduction units 60 and 70 may be referred to as optical interference reduction units or layers if the reduction of the attraction is designed for the reduction of the optical interference or oil slick problem. A gap or a space S which is formed between the display panel 20 and the touch panel 10 may be maintained by a support structure which is similar to a side surface support portion 31 shown in FIG. 1. However, the gap or the space S may be thinner than the gap illustrated in FIG. 1, thereby reducing the thickness of the mobile device. Further, the reduction of attraction may refer to a reduction or a prevention of a contacted state in which the touch panel 10 and the display panel 20 contact or remain contacted with each other.

The attraction reduction unit 60 or 70 may be disposed on one or more surfaces of a first surface 16, which is one surface of the touch panel 10 facing the display panel 20, and a second surface 17, which is one surface of the display panel 20 facing the touch panel 10.

The display panel 20 is configured to output an image. A display device, such as a liquid crystal display (LCD), may be used for the display panel, but aspects are not limited as such.

The display panel 20 may include a light guiding plate, a prism, a back side polarizing plate, a back side glass, a front side glass, and a front side polarizing plate in order from the lower housing toward the touch panel 10.

Since the front side polarizing plate in the display panel 20 mainly includes a film, the front side polarizing plate generally has a smooth surface.

The touch panel 10 may be an electrostatic panel, but is not limited thereto. For example, a pressure sensitive touch panel or the like may be used. Throughout the specification, one type of electrostatic touch panel is described as an example, but aspects are not limited thereto. Various types of electrostatic panels may be used. For example, a structure may be provided in which a single electrode layer is formed and electrodes are formed on front and rear surfaces of the electrode layer.

Further, an air gap S (“air gap layer”) may be formed by disposing an electrode layer on the touch panel 10 so as to be apart or separated from the display panel 20 by a predetermined gap. A user may input information to the mobile device by touching the surface of the touch panel 10. The touch panel 10 and the display panel 20 may be formed so as to be apart from each other by a gap of 0.5 mm or less. The touch panel 10 and the display panel 20 may be disposed according to the desired product size.

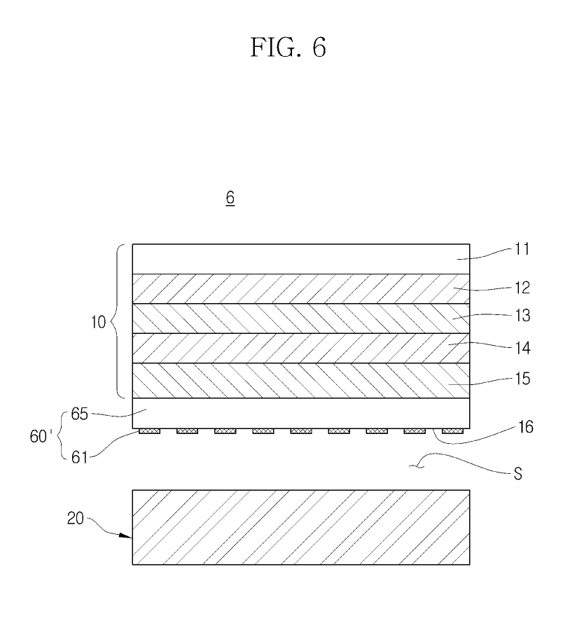

The touch panel 10 may include a window glass 11, a first adhesive layer 12, an upper electrode 13, a second adhesive layer 14, and a lower electrode 15 in order from the outer exposed surface to the first surface 16 facing the display panel 20. However, aspects of the present invention are not limited thereto. For example, the upper electrode 13 and the lower electrode 15 may be formed in one layer, and one or more adhesive layer may be omitted according to a manufacturing process. Further, a base layer (or a “substrate”) may be a layer for disposing another layer thereon. For example, a base layer may be, e.g., a base layer 65 shown in FIG. 6, the window glass 11 shown in FIG. 3, and a portion of the electrodes 13 and 15, which may be a polyethylene terephthalate (PET) film or a carrier film formed of glass on which an electrode pattern is formed.

As the first and second adhesive layers 12 and 14, an adhesive tape such as an optical clear adhesive may be used. However, various transparent adhesive materials may be used instead of the optical clear adhesive.

The upper electrode 13 and the lower electrode 15 may be disposed in a manner such that an electrode pattern is formed by a transparent electrode material on a base layer, such as a polyethylene terephthalate (PET) film or a carrier film formed of glass or the like. The electrode pattern may be formed on the carrier film by using a thin film coating machine, such as a roll-to-roll machine, or a depositing machine, such as a sputtering machine.

The attraction reduction units 60 and 70 may include one or more patterns 61 and 71, respectively, having a thickness on the order of micro meters on one or more surfaces of the first surface 16 and the second surface 17 to decrease or prevent the contact between the touch panel 10 and the display panel 20 that may cause the optical interference.

In the case of the display unit 4 of the mobile device illustrated in FIG. 3, the attraction reduction unit 60 may be disposed on the touch panel 10 so as to have one or more patterns 61 on the first surface 16 facing the display panel 20. In the case of the display unit 5 of the mobile device illustrated in FIG. 4, the attraction reduction unit 70 may be disposed on the display panel 20 so as to have one or more patterns 71 on the second surface 17 facing the touch panel 10.

Further, the attraction reduction unit 60 or 70 may be disposed on both the display panel 20 and the touch panel 10.

The optical interference phenomenon is related to the sizes of the touch panel and the display panel, the gap between the two panels, and the surface roughness of the first and second surfaces 16 and 17. Specifically, the optical interference phenomenon is more likely if the size of the touch panel 10 or the display panel 20 is larger and thinner, the surface roughnesses of the first and second surfaces 16 and 17 are less, or the gap between the panels is narrower.

The optical interference phenomenon may be resolved by increasing the surface roughness while maintaining the sizes of the display panel and the touch panel and the gap therebetween. For example, the attraction reduction unit 60 or 70 may be disposed on the facing first and/or second surfaces 16 and 17 of the touch panel 10 and the display panel 20, respectively, so as to roughen at least one of the first and second surfaces 16 and 17. Thus, the van der Waals force which is acting between the touch panel 10 and the display panel 20 may decrease and the physical attraction between the touch panel 10 and the display panel 20 may be reduced. Accordingly, the optical interference phenomenon may be reduced.

The pattern 61 or 71 may be disposed having a thickness on the order of micro meters on one or more surfaces of the first surface 16 and the second surface 17. More specifically, the thickness may be 1 to 1000 μm. If the thickness of the pattern 61 or 71 is less than 1 μm, it may be difficult to increase the surface roughness and the effect of preventing the optical interference phenomenon may not be expected. If the thickness of the pattern 61 or 71 is more than 1000 μm, the thickness of the product may be affected.

Since the pattern 61 or 71 has a thickness on the order of micro meters, the optical interference phenomenon may be prevented without affecting the thickness of the product. Accordingly, the disclosure may be applied to the manufacture of the product having a thinner touch input display while reducing the optical interference problem.

Further, the pattern 61 or 71 may be formed of a transparent material so as to satisfy various conditions for forming the pattern or the attraction reduction unit. For example, various conditions for ensuring the transparency of the display, e.g., the transparency and the light transmitting property of the display, may be ensured and thin and small patterns may be formed so as not to affect the thickness of the mobile device for the purpose of a decrease in thickness of the product.

As the transparent material, various materials having a light transmitting property may be used. For example, a transparent electrode material such as indium tin oxide (ITO) may be used.

Since the pattern 61 or 71 includes the transparent material, the display screen may transmit light, thus the display screen having a high transparency may be realized. Furthermore, the touch panel 10 provides a pattern which includes a transparent electrode material and has a thin thickness. The method of forming the pattern will be described later in the description for the manufacturing method.

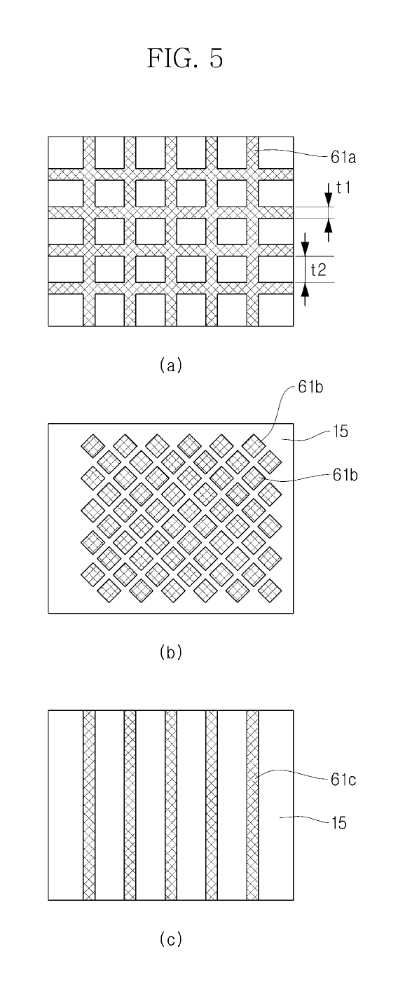

FIG. 5 illustrates patterns which may form attraction reduction units according to exemplary embodiments of the present invention.

(a), (b), and (c) of FIG. 5 illustrate the shapes of one or more patterns 61 that may be formed on the touch panel 10. Furthermore, the pattern 61 may be applied to the shapes of one or more patterns 71 which are formed on the surface of the display panel 20 facing the touch panel 10. In addition, one or more patterns 61 or 71 may form the attraction reduction unit 60 or 70.

Further, one or more patterns 61 may be patterned with a structure and shape on the lower electrode 15 of the touch panel 10 toward the display panel 20 so as to reduce the optical interference phenomenon. For example, a lattice-shaped pattern 61a of (a) of FIG. 5, a diamond-shaped pattern 61b of (b) of FIG. 5, and a bar-shaped pattern 61c of (c) of FIG. 5 may be formed.

Since the pattern 61 may be adjusted to have various shapes and be formed at various positions, the influence on the display screen may be reduced. Also, since one or more patterns are formed so as not to be connected to the other components, there is no need to consider the power consumption or noise. Since only a single physical layer is additionally provided instead of the electrode layer of the touch panel to which electric power is applied, no electric power is consumed and no noise is generated by the layer having the patterns when operating the touch panel.

Further, unlike the laminated structure which connects the touch panel 10 and the display panel 20 to each other with an adhesive intermediate layer, touch panel 10 and the display panel 20 are not fixed to each other. Accordingly, even when any one of products has a defect in the manufacturing process of the product, there is no need to replace both the touch panel 10 and the display panel 20, and the yield rate of the product may be improved.

Referring to (a) of FIG. 5, the width t1 of one or more patterns may be formed so as to be smaller than the gap t2 between the adjacent patterns so that the pattern area to be formed is reduced.

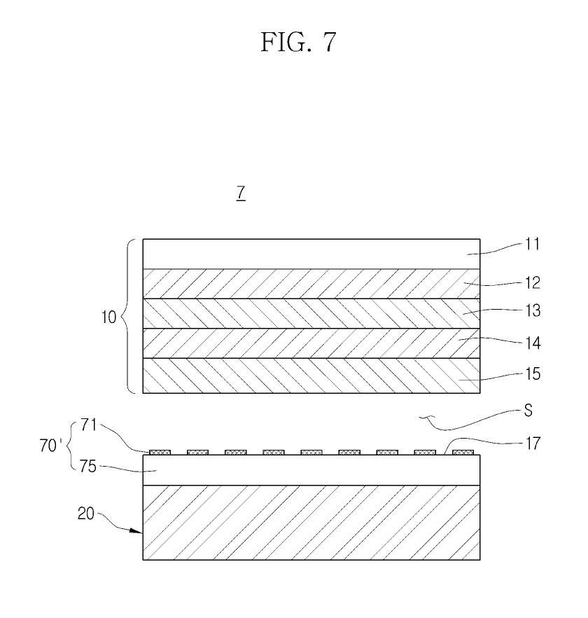

FIG. 6 is a cross-sectional view illustrating a display unit in a mobile device according to an exemplary embodiment of the present invention, and FIG. 7 is a cross-sectional view illustrating a display unit in a mobile device according to an exemplary embodiment of the present invention.

As shown in FIG. 6, an attraction reduction unit 60′ may include a base layer 65 disposed on a surface facing the display panel 20 and one or more patterns 61, which are formed on the base layer 65 so as to face the display panel 20. Further, as shown in FIG. 7, an attraction reduction unit 70′ may include a base layer 75 disposed on a surface facing the touch panel 10 and one or more patterns 71, which are formed on the base layer 75 so as to face the touch panel 10.

Referring to FIG. 6, the base layer 65 and one or more patterns 61 may be sequentially disposed on the touch panel 10, and the base layer 65 may be a film or a plate including a synthetic material such as a polyethylene terephthalate (PET) film, or a carrier film or a plate including a glass material similar to the material of the lower electrode. The base layer may be a film or a plate which includes a transparent thin material. One or more patterns 61 may be formed on the carrier film in a manner similar to a substrate treatment process.

Referring to FIG. 7, a base layer 75 and one or more patterns 71 may be sequentially disposed on the display panel 20. More specifically, in the embodiment illustrated in FIG. 7, the physical attraction between the touch panel 10 and the display panel 20 may be reduced in a way similar to the embodiment illustrated in FIG. 6 by arranging one or more patterns 71 on the base layer 75 which corresponds to the outermost layer disposed in the direction facing the touch panel 10. The base layer 75 may be a polarizing plate of the display panel 20, and may be a dummy polarizing plate which includes one or more patterns 71 on the polarizing plate.

Since the dummy electrode or the dummy polarizing plate may have a thickness in a range of about 0.05 to about 0.1 mm, one or more patterns may be carried and applied as a single component. That is, by using a method of adding the dummy electrode to the first surface 16 of the touch panel 10 and/or attaching the dummy polarizing plate to the second surface 17 of the display panel 20 as an additional thin layer, it may be possible to dispose the attraction reduction unit capable of reducing or preventing the optical interference phenomenon without complex additional processes.

Further, the electrode layers 13 and 15 that are used in the touch panel may be directly used as the optical interference reduction structure. That is, an optical interference reduction structure, which induces a repulsive force by using the attraction reduction unit 70′ of the display panel 20 and the electrode layers 13 and 15 of the touch panel 10, may be formed. Accordingly, since the optical interference reduction structure is formed by using the components used in the product without any additional layer, the manufacturing cost may be decreased and the efficiency may be increased and ensured.

Specifically, the attraction reduction unit 60′ or 70′ may be formed by attaching the base layer 65 or 75 provided with the pattern 61 or 71 to the touch panel 10 or the display panel 20 through a simple method using a transparent tape such as an optical clear adhesive (OCA).

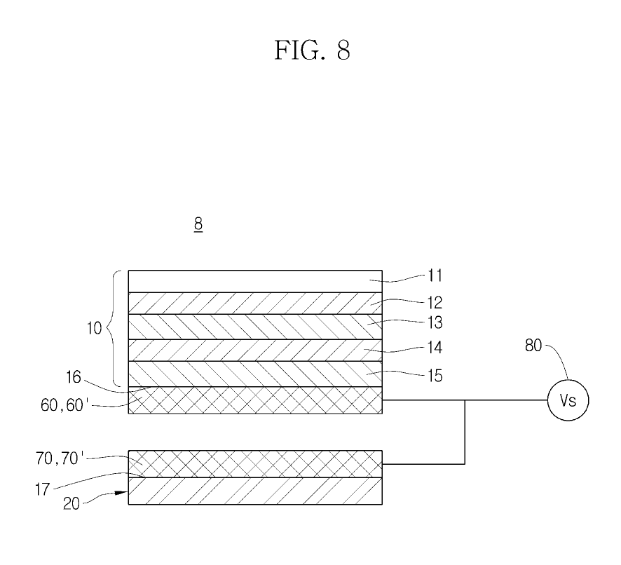

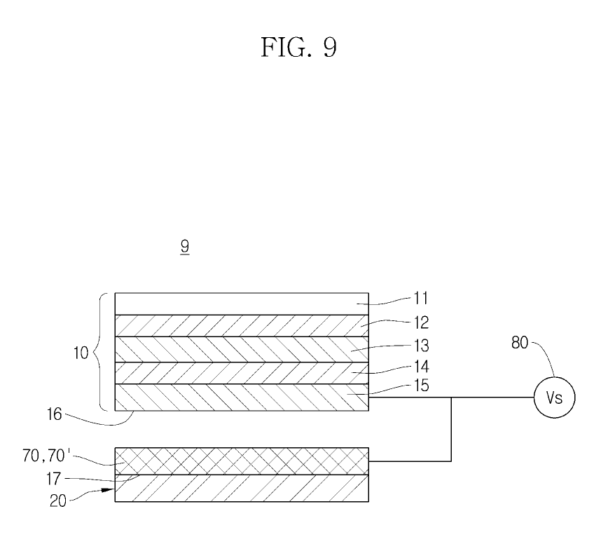

FIG. 8 is a cross-sectional view illustrating a display unit in a mobile device according to an exemplary embodiment of the present invention, and FIG. 9 is a cross-sectional view illustrating a display unit in a mobile device according to an exemplary embodiment of the present invention.

Referring to FIG. 8, in a display unit 8, the attraction reduction units 60, 60′, 70, and 70′ are disposed on both the first surface 16 and the second surface 17, and the patterns of the respective attraction reduction units 60, 60′, 70, and 70′ are charged to have the same polarity to generate a repulsive force between the attraction reduction units 60, 60′, 70, and 70′, The repulsive force may be induced between the touch panel 10 and the display panel 20 from the connected voltage source (VS) 80 (“power supply unit 80”). The attraction reduction units 60, 60′, 70, and 70′ may correspond to the attraction reduction units 60, 60′, 70, and 70′ illustrated in FIG. 3, FIG. 4, FIG.6, and FIG. 7, respectively, but aspects are not limited as such. Further, a repulsive force generator may comprise the power supply unit 80 and a controller to control power supply to generate a repulsive force.

Specifically, the attraction reduction unit 60, 60′, 70, and 70′ may include the first attraction reduction units 60 or 60′ that is disposed on the first surface 16 and the second attraction reduction units 70 or 70′ that is disposed on the second surface 17.

The first attraction reduction units 60 and 60′ include one or more first patterns, which are formed on the touch panel 10, and the second attraction reduction units 70 and 70′include one or more second patterns, which are formed on the display panel 20.

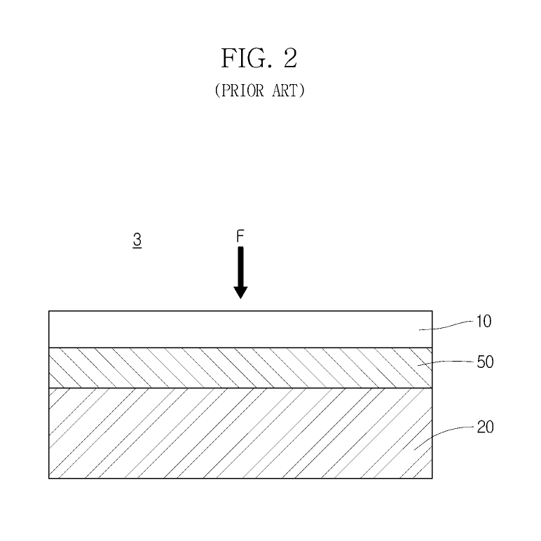

The first pattern and the second pattern may be one or more patterns 61 or 71 that are illustrated in FIG. 2 to FIG. 7, one or more first or second patterns that are formed at the center portion, or first or second patterns that are repetitively formed in a predetermined shape, for example.

The first pattern and the second pattern are disposed so as to face each other, and are charged to have the same polarity, whereby a repulsive force may be induced between the touch panel and the display panel. In particular, if the first pattern and the second pattern have corresponding pattern shapes at the corresponding positions, the repulsive force may increase.

The first pattern and the second pattern may be symmetrical. For the symmetrical structure, corresponding patterns may be symmetrically formed at the corresponding positions with respect to a plain of symmetry, which is parallel to layers 10 and 20 and located between the first pattern and the second pattern. For example, the first pattern and the second pattern may be formed so as to have a partially overlapped area when viewed in a direction perpendicular to the plain of symmetry and induce a repulsive force.

For example, when the first pattern is the bar-shaped pattern shown in (c) of FIG. 5, the second pattern may also be formed as a bar-shaped pattern which corresponds to the first pattern. Accordingly, the repulsive force may be formed along the longitudinal direction of the bar-shaped pattern.

The physical attraction between the touch panel 10 and the display panel 20 may be avoided by inducing the repulsive force between the first surface 16 and the second surface 17. The electric power of the same polarity is applied to the attraction reduction units 60, 60′, 70, and 70′ may generate the repulsive force to cancel out the attraction between the touch panel 10 and the display panel 20. As a result, the optical interference phenomenon may be reduced.

Referring to FIG. 9, the optical interference reduction structure of the display unit 9 in the mobile device includes the lower electrode 15 that is disposed on the touch panel 10 so as to face the display panel 20 and is provided with the electrode pattern, where the second surface 17 is provided with the attraction reduction units 70 and 70′. The lower electrode 15 and the patterns of the attraction reduction units 70 and 70′ are charged to the same polarity, thereby inducing the repulsive force between the touch panel 10 and the display panel 20.

The attraction reduction units 70 and 70′ may include one or more patterns 71 that are formed on the display panel 20. Further, one or more electrodes may be formed on the touch panel 10. The repulsive force may be induced between the first surface 16 and the second surface 17 by using the electrode of the touch panel 10 and one or more patterns 71 of the attraction reduction units 70 and 70′ of the second surface without any additional configuration.

That is, the electrode pattern of the lower electrode 15 of the touch panel 10 and one or more patterns 71 (see FIG. 7) of the attraction reduction units 70 and 70′ disposed on the second surface 17 may be formed so as to be symmetrical or to have the overlapping area. One or more patterns 71 of the second surface 17 may be formed in an area corresponding to the electrode pattern of the lower electrode 15 such that the configuration is symmetrical to the electrode pattern of the lower electrode 15 and have the overlapping area.

Accordingly, it is possible to reduce the physical attraction between the touch panel 10 and the display panel 20 by the repulsive force generated by the application of the same polarity to the lower electrode 15 of the touch panel 10 and one or more patterns 71 of the display panel 20.

The electrode pattern of the lower electrode 15 and one or more patterns 71 of the attraction reduction units 70 and 70′ may be formed so as to have the corresponding shapes at the corresponding positions, and are charged to the same polarity, thereby inducing the repulsive force between the touch panel 10 and the display panel 20. In particular, when the electrode pattern and one or more patterns 71 have the corresponding shapes at the corresponding positions, the repulsive force may increase.

According to the structure illustrated in FIG. 9, since the repulsive force is formed by the attraction reduction units 70 and 70′ disposed on the second surface 17 and the lower electrode 15 of the touch panel 10 without disposing the attraction reduction unit on the first surface 16, the optical interference reduction structure may be implemented without an additional layer on the first surface 16. In this case, the structure of the display unit in the mobile device may become simpler and the thickness of the display unit may be decreased.

Referring to FIG. 8 and FIG. 9, the display unit 8 or 9 in the mobile device may further include a power supply unit 80 that may supply electric power to the attraction reduction unit of the first surface 16 and the second surface 17 (“the structure shown in FIG. 8”) or the lower electrode 15 and the attraction reduction unit 70 or 70′ of the second surface 17 (“the structure shown in FIG. 9”). The power supply unit 80 may be controlled by a control unit (not shown) so as to supply the same electric power to the lower electrode or one or more attraction reduction units at a predetermined time point.

An additional power supply unit which is connected to the attraction reduction unit may be further provided, which reduces an interference phenomenon or noise in other components due to the operation of the attraction reduction unit.

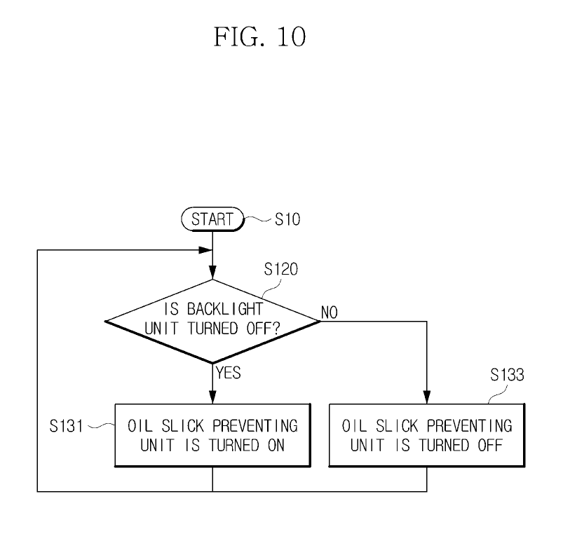

FIG. 10 is a flowchart illustrating a method for driving a mobile device according to an exemplary embodiment of the present invention.

As shown in FIG. 8 and FIG. 9, if the electric power is applied to one or more attraction reduction units or the lower electrode so as to induce the repulsive force, power consumption or noise between other components may occur.

Thus, if the user does not operate the mobile device, that is, the backlight unit of the display panel is turned off, the electric power may be applied to the attraction reduction unit of the first surface 16 and the second surface 17 as shown in FIG. 8 or the lower electrode 15 and the attraction reduction unit of the second surface 17 as shown in FIG. 9.

The display unit may be turned off if a predetermined condition that indicates the user is not operating the mobile device is satisfied, and if the predetermined condition is satisfied, the backlight unit may also be turned off. Specifically, in the first case in which in the user does not use the mobile device or the second case in which the mobile device does not execute a specific application process, that is, an application core falls into a sleep mode, the backlight unit of the display panel may be turned off or the touch panel may be turned off.

The electric power may be applied to the attraction reduction unit of the first surface 16 and the second surface 17 or the lower electrode 15 and the attraction reduction unit of the second surface 17 while the backlight unit of the display panel is turned off because the operations of the other components are disturbed when the electric power is applied to the attraction reduction unit of the first surface 16 and the second surface 17 or the lower electrode 15 and the attraction reduction unit of the second surface 17 while the user operates the mobile device or the application core is operated.

Referring to FIG. 10, if the mobile device is turned on in operation S10, the touch unit may be turned on or off depending on the condition whether the backlight unit of the display panel is turned off. Further, the optical interference reduction structure may become inactive or active depending on the condition whether the backlight unit of the display panel is turned off.

Specifically, if the backlight unit of the display panel is turned off in operation S120, the electric power is applied to the attraction reduction units 60, 60′, 70, and 70′ of the first surface 16 and the second surface 17 (see FIG. 8) or the lower electrode 15 and the attraction reduction units 70 and 70′ of the second surface 17 (see FIG. 9) in operation S131. If it is determined that the backlight unit of the display panel is not turned off in the operation S 20, the electric power to the attraction reduction units 60, 60′, 70, and 70′ may not be provided in operation S133.

Further, if the backlight unit of the display panel is turned off, the electric power may be applied to the attraction reduction units 60, 60′, 70, and 70′ of the first surface 16 and the second surface 17 (see FIG. 8) or the lower electrode 15 and the attraction reduction units 70 and 70′ of the second surface 17 (see FIG. 9) at a predetermined time interval, and a control unit (not shown) including a timer and the like may be further provided. For example, the electric power may be applied for a first time period and the electric power supply may be stopped for a second time period in a repetitive manner.

The optical interference phenomenon is more likely to occur particularly when the user puts the mobile device in a pocket or a bag for a long period of time without using the mobile device. Thus, when the backlight unit of the display panel is turned off in the case where the mobile device is not used, the optical interference phenomenon may be reduced by supplying the electric power to the attraction reduction unit while preventing an erroneous operation of a touch module by terminating the electric power supply to the touch panel 10.

Further, in an active mode in which the user uses the mobile device, the mobile device may be used by supplying power to the touch panel 10 for operation without supplying the electric power to the attraction reduction unit.

The optical interference phenomenon may be prevented with the thickness of less than 0.1 mm by the application of the attraction reduction unit. Also, an increase in manufacturing cost caused by the degradation of the yield rate of the product or an increase in the defective product ratio may be reduced in comparison with the laminated structure. In addition, the waste of power may be reduced by supplying the electric power only at a necessary time without supplying the electric power to the attraction reduction unit or the touch panel continuously.

For example, if the backlight unit of the display panel is turned off, the electric power may be applied to the attraction reduction units 60, 60′, 70, and 70′ of the first surface 16 and the second surface 17 or the lower electrode 15 and the attraction reduction units 70 and 70′ of the second surface 17 at a predetermined time interval. Accordingly, since the electric power is not continuously supplied to the attraction reduction unit, the excessive power consumption of the electric power may be prevented.

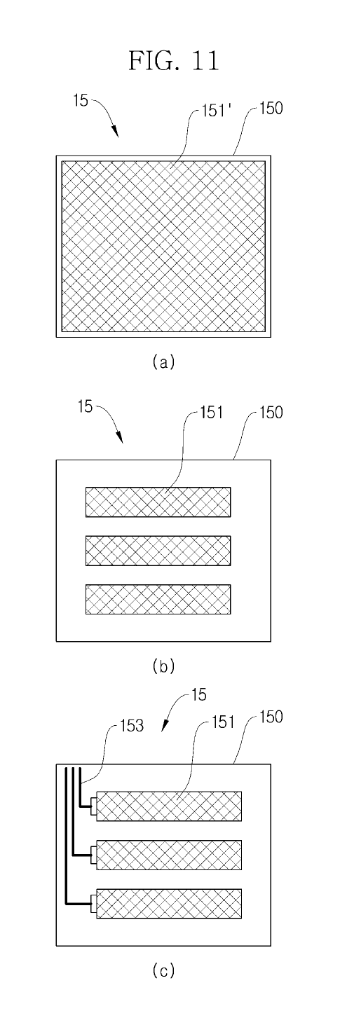

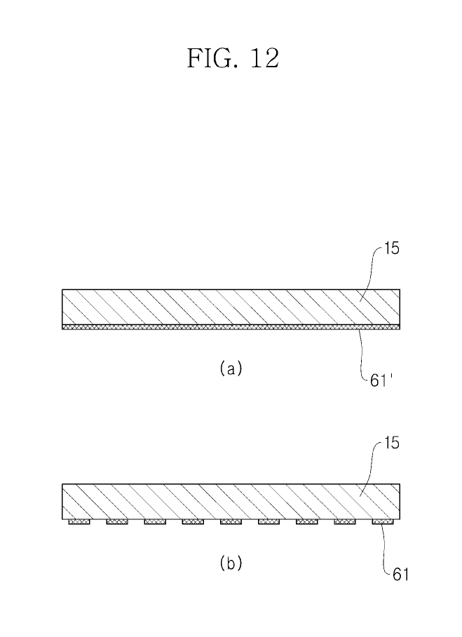

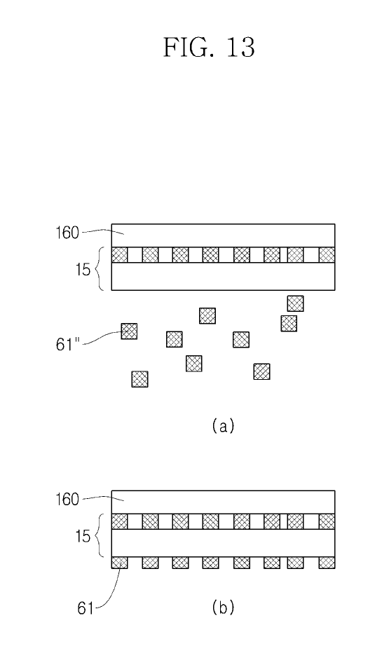

Hereinafter, referring to FIG. 11, FIG. 12, and FIG. 13, a method for manufacturing a display unit in a mobile device will be described in detail.

The method for manufacturing a mobile device may include producing a touch panel configured to be touched by a user and a display panel configured to output an image in a touch input type mobile device; and disposing one or more layers of attraction reduction units on at least one of a first surface, a surface in the touch panel facing the display panel, and a second surface, a surface of the display panel facing the touch panel, so as to reduce a physical attraction between the touch panel and the display panel.

Each pattern may be formed on a partial area of at least one of the first surface and the second surface so as to protrude by a thickness on the order of micro meters.

Before the connection of the touch panel and the display panel, forming a circuit pattern, such as a wire pattern for supplying electric power to the attraction reduction unit, may be further provided if the electric power is applied to the attraction reduction unit to induce the repulsive force.

Furthermore, if the electric power is applied to the attraction reduction unit, inducing the repulsive force by supplying the electric power at a predetermined time interval or a predetermined condition may be further provided after the touch panel and the display panel are connected to each other.

Since the attraction reduction unit having one or more patterns is provided between the touch panel and the display panel, the optical interference phenomenon may be reduced, and the transparency of the display screen may be maintained without a serious deterioration.

Further, since the touch panel and the display panel can be easily separated from each other in comparison with the laminated structure, the yield rate of the product may be improved and the defective product ratio and manufacturing costs may decrease.

The attraction reduction unit may be formed by attaching one or more patterns to at least one of a first surface, a surface of the touch panel facing the display panel, and a second surface, a surface of the display panel facing the touch panel. Further, the attraction reduction unit may be disposed on the first surface and/or the second surface by arranging one or more patterns on the base layer disposed on the first surface and/or the second surface.

The attraction reduction unit may include the base layer to be easily carried and handled. Specifically, the step of disposing one or more layers of attraction reduction unit may include disposing the base layer provided with the one or more patterns and laminating the base layer on at least one of the first surface and the second surface such that one or more patterns of one surface face the other surface and the physical attraction between the touch panel and the display panel is reduced.

The attraction reduction unit may be formed by directly arranging the pattern on the base layer without forming the pattern on the touch panel or the display panel and attaching the base layer having the pattern to the touch panel or the display panel as one component. Accordingly, the manufacturing process may become simpler.

As described above, the pattern may be formed in a direction in which the base layer, the touch panel, or the display panel faces each other. One or more patterns may be formed on the base layer, the touch panel, or the display panel by partial etching or quasi-plating.

The touch panel having the lower electrode disposed on the lowermost surface, that is, the lower electrode pattern disposed on the substrate may be provided. Further, the polarizing plate may be disposed on the uppermost surface of the display panel in the direction such that the display panel displays images to the outside.

The one or more pattern may be formed from the pattern material layer having a thickness on the order of micro meters on the base layer, the touch panel, or the display panel.

The one or more patterns may be formed from the pattern material layer in a manner such that a mask for forming a desired pattern is formed by a method such as photolithography and only a part of the pattern material layer is exposed to be partially etched.

According to the aspects, since the surface roughness of the portion provided with the pattern increases, the optical interference phenomenon may be reduced.

Specifically, if one or more patterns are formed on the touch panel, such partial etching may be performed along with the process of manufacturing the lower electrode.

Further, in order to form the attraction reduction unit by quasi-plating, the one or more patterns may be formed by immersing one or more surfaces of the first surface of the touch panel having an electrode pattern formed therein and the second surface of the display panel into a solution containing a pattern material and applying electric power to the electrode pattern so that a pattern corresponding to the electrode pattern is formed on the surface immersed into the solution.

FIG. 11 is a process flow diagram illustrating a method for manufacturing a lower electrode according to an exemplary embodiment of the present invention.

Referring to (a) of FIG. 11, a substrate 150 that is formed of a polyethylene terephthalate film or glass is provided for manufacturing the lower electrode 15. Then, an electrode material layer 151′ may be disposed on the substrate 150.

As shown in (b) of FIG. 11, a lower electrode pattern 151 having a desired shape may be formed or disposed on the substrate 150 in a manner such that a mask is formed by photolithography and is partially etched, for example. However, the electrode pattern may be formed or disposed by various methods of disposition.

As shown in (c) of FIG. 11, a wire pattern 153 that connects the electrode pattern 151 may be formed by printing an electrode paste containing a conductive material, such as silver.

In the lower electrode 15, the gap between the electrode patterns 151 may be very narrow, e.g., approximately 0.1 to 0.2 mm. Furthermore, the gap between the wire patterns 153 may be approximately 0.03 to 0.08 mm, which is narrower than the gap between the lower electrode patterns.

As described above, the microscopic pattern technique may be applied in order to form the lower electrode pattern or the wire pattern having a microscopic size. However, since the gap is very narrow, a defect such as short-circuit or a deviation from the reference resistance (100 to 200Ω) may occur, which may be a main factor causing malfunction.

If a flexible material, such as a polyethylene terephthalate, is used as the substrate 150, a defect may occur due to the deformation that may be generated in the process of forming the lower electrode pattern 151 or the wire pattern 153.

Specifically, if one or more patterns are formed on the lower surface of the lower electrode to prevent the optical interference and the one or more patterns for reducing the optical interference are formed in advance, the manufacturing defect of the lower electrode may occur due to the above-described reason. If the manufacturing defect occurs, the effort and cost spent for the entire process becomes useless.

To avoid the above mentioned problems, the lower electrode pattern may be first completely formed, and then one or more patterns for reducing an optical interference, regardless of the defect or the reliability, may be formed by the same microscopic pattern forming method, thereby simplifying the product manufacturing process.

FIG. 12 is a process flow diagram illustrating a method for manufacturing an attraction reduction unit according to an exemplary embodiment of the present invention.

Referring to FIG. 12, the lower electrode 15 may be formed by the method shown in FIG. 11, and an attraction reduction unit including one or more patterns 61or 61′ may be formed on the lower electrode 15.

Referring to (a) of FIG. 12, the lower electrode provided with the lower electrode pattern may be formed or disposed, and a pattern material layer 61′ may be formed or disposed on a surface without the lower electrode pattern.

Referring to (b) of FIG. 12, the one or more patterns 61 may be formed from the pattern material layer 61′ in a manner such that a mask for forming a desired pattern may be applied by a method such as photolithography and only a part thereof is exposed for partial etching.

The partial etching may be applied to the attraction reduction unit including the base layer.

FIG. 13 is a process flow diagram illustrating a method for forming an attraction reduction unit according to an exemplary embodiment of the present invention.

Referring to (a) of FIG. 13, the lower electrode 15 is formed by the method illustrated in FIG. 11, and then an isolation layer 160 is attached to a surface of the lower electrode 15 provided with the electrode pattern 151. Then, the lower electrode 15 provided with the isolation layer 160 may be immersed into an electrolytic solution containing a pattern material 61″.

Next, electric power is applied to the lower electrode 15 as shown in (b) of FIG. 13 so that the pattern material 61″ can be attached to the surface of the substrate of the lower electrode in the direction of the display panel so as to have a pattern shape corresponding to the position of the lower electrode pattern 61.

In this way, when the lower electrode pattern 61 is formed by quasi-plating, the thickness of the one or more patterns 61 may be adjusted by adjusting the electric power application time, the voltage, and the like.

The one or more patterns 61 for reducing the optical interference may be formed in a manner such that the lower electrode pattern formed on the lower electrode 15 is duplicated to the opposite surface of the substrate. One or more patterns may be more reliably formed while the substrate is less affected. Accordingly, the more reliable product may be provided.

Further, one or more patterns for reducing the optical interference may be formed of a transparent electrode material. Since the transparent electrode material is used, a thin pattern having a thickness on the order of micro meters may be formed by the method of the embodiment of (a), (b), and (c) of FIG. 11. In addition, the optical interference reduction structure may be formed by a simpler method through the application of the similar pattern forming process by using the transparent electrode material forming the lower electrode without any additional process.

That is, a pattern having a thickness of 1 to 1000 μm may be formed by forming the one or more patterns through the partial etching and the quasi-plating. Accordingly, since the optical interference reduction structure may be formed without affecting the size of the entire product, the product may have a decreased thickness.

Further, one or more patterns may include patterns of one or more shapes in a group of a bar shape, a lattice shape, a diamond shape, and the like. Accordingly, since a pattern of a desired shape is formed at a desired portion so as to expose the remaining area, the transparency of the display screen may be maintained and ensured.

According to aspects, it may be possible to provide a mobile device and a manufacturing method therefor capable of providing a guaranteed transparency of a display screen, increasing a yield rate of a product, and decreasing manufacturing cost while reducing an optical interference phenomenon with an increase in size of a display screen and a decrease in thickness of a product.

Specifically, since the attraction reduction unit may be provided in a space formed between the touch panel and the display panel, there is no additional increase in thickness caused when widening a gap between the touch panel and the display panel to reduce the optical interference. Accordingly, a decrease in thickness of the product may be realized.

Further, the transparent electrode material may be used for the attraction reduction unit. In this case, since the transparency of the display is not deteriorated (the screen is seen by a user without any disturbance), the excellent transparency of the display may be guaranteed even when the attraction reduction unit is formed.

In addition, since the low-cost attraction reduction unit reduces the optical interference phenomenon, the manufacturing cost does not increase even when the attraction reduction unit is formed. Furthermore, in the case where the existing transparent electrode material is directly used, only a process of attaching the dummy transparent electrode pattern may be additionally provided in the existing process, and hence the manufacturing efficiency is improved. Accordingly, the manufacturing cost of the product may be decreased and the efficiency of the process may be improved.

Furthermore, in the case of increasing the surface roughness by forming the dummy transparent electrode pattern, no additional current consumption occurs and no interference with the other components or the touch panel occurs.

Furthermore, in the case of using the repulsive force, only a small amount of current may be periodically supplied. Since the power consumption may not be significant and the attraction reduction unit may be operated even when the backlight unit of the display panel is turned off, the attraction reduction unit may be operated without any interference with the other components, particularly the touch panel. Accordingly, the optical interference phenomenon may be more efficiently reduced.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a touch panel having a first surface;
a display panel having a second surface configured to face the first surface; and
an attraction reduction layer disposed on at least one of the first surface and the second surface to reduce attraction between the first surface and the second surface.

2. The terminal of claim 1, wherein the touch panel comprises a base layer and an indium tin oxide (ITO) surface disposed on the base layer, and wherein the first surface corresponds to the ITO surface or an exposed surface of the base layer.

3. The terminal of claim 2, wherein the base layer comprises polyethylene terephthalate (PET) film or glass.

4. The terminal of claim 1, wherein the attraction reduction layer comprises a first indium tin oxide (ITO) pattern formed by etching an ITO material, the first ITO pattern having a non-flat surface to reduce the attraction.

5. The terminal of claim 4, wherein the touch panel further comprises an electrode pattern, and
wherein the electrode pattern and the first ITO pattern have a same pattern.

6. The terminal of claim 4, wherein the attraction reduction layer comprises a base layer between the first ITO pattern and the first surface or comprises a base layer between the first ITO pattern and the second surface.

7. The terminal of claim 4, wherein the first ITO pattern comprises at least one of a lattice-shaped pattern, a diamond-shaped pattern, and a bar-shaped pattern.

8. The terminal of claim 4, further comprising:
a second ITO pattern disposed on the second surface, wherein the attraction reduction layer being disposed on the first surface; and
a gap formed between the first ITO pattern and the second ITO pattern.

9. The terminal of claim 4, further comprising:
a repulsive force generator to charge the first ITO pattern to generate a repulsive force between the first ITO pattern and another electrode pattern.

10. The terminal of claim 1, further comprising:
a repulsive force generator to charge a first electrode pattern included in the attraction reduction layer and a second electrode pattern; and
a gap between the attraction reduction layer and the second electrode pattern,
wherein the touch panel comprises the second electrode pattern, and
the attraction reduction layer is disposed on the second surface.

11. The terminal of claim 10, wherein the repulsive force generator is configured to be switched off while a backlight unit of the display panel is turned on.

12. A method for manufacturing a touch-input display, comprising:
disposing a first pattern on at least one of a first surface of a touch panel and a second surface of a display panel, the first pattern facing the other of the first surface and the second surface to reduce attraction between the first surface and the second surface; and
arranging the touch panel and the display panel to have a gap layer between the touch panel and the display panel.

13. The method of claim 12, wherein the first pattern having a non-flat surface to reduce the attraction.

14. The method of claim 12, wherein the first pattern is formed by etching of an ITO material.

15. The method of claim 12, further comprising:
disposing a first indium tin oxide (ITO) material on a third surface of a substrate, the substrate comprising a polyethylene terephthalate (PET) film or a carrier film formed of glass;
forming an electrode by etching the first ITO material;
disposing a second ITO material on the first surface of the touch panel, the first surface of the touch panel corresponding to an opposite surface of the third surface of the substrate; and
forming the first pattern on the first surface of the touch panel by partially etching the second ITO material.

16. The method of claim 12, further comprising:
disposing a first indium tin oxide (ITO) material on a third surface of a substrate, the substrate comprising a polyethylene terephthalate (PET) film or a carrier film formed of glass;
forming an electrode by etching the first ITO material; and
forming the first pattern on an opposite surface of the third surface of the substrate by immersing the substrate into an electrolytic solution comprising a pattern material and applying an electric power to the electrode formed on the third surface of the substrate, the opposite surface of the third surface of the substrate corresponding to the first surface of the touch panel.

17. The method of claim 12, further comprising:
disposing the first pattern on the first surface;
disposing a second pattern on the second surface; and
connecting a repulsive force generator to the first pattern and the second pattern, the first and second patterns being electrode patterns.

18. A mobile device, comprising:
a touch panel comprising a first electrode having a first electrode pattern;
a display panel comprising a second electrode pattern;
a repulsive force generator to generate a repulsive force between the second electrode pattern and the touch panel; and
a gap layer between the touch panel and the display panel.

19. The mobile device of claim 18, wherein:
the first electrode pattern and the second electrode pattern have corresponding pattern shape at corresponding positions.

20. The mobile device of claim 18, wherein:
the repulsive force generator generates a repulsive force between the second electrode pattern and the first electrode pattern or between the second electrode pattern and a third electrode pattern included in the touch panel.
